(19) United States
(12) Patent Application Publication
(10) Pub. No.: US 2024/0417841 A1
(43) Pub. Date: Dec. 19, 2024

(54) COATING FOR HYDRAULIC RODS AND OTHER SLIDING COMPONENTS AND METHOD OF PRODUCING THE SAME

(71) Applicants: Ardy S. Kleyman, Carmel, IN (US); Adam J. Smith, Brownsburg, IN (US); Daming Wang, Carmel, IN (US); Levi J. Von Bokel, Troy, IL (US)

(72) Inventors: Ardy S. Kleyman, Carmel, IN (US); Adam J. Smith, Brownsburg, IN (US); Daming Wang, Carmel, IN (US); Levi J. Von Bokel, Troy, IL (US)

(21) Appl. No.: 18/334,782

(22) Filed: Jun. 14, 2023

(51) Int. Cl. C23C 4/129; C23C 4/08; C23C 4/18

(52) U.S. Cl. CPC C23C 4/129; C23C 4/08; C23C 4/18

(57) ABSTRACT

An optimized metallic thermal spray coating able to achieve a suitable surface finish such that it slides against a hydraulic seal without damaging the surface of the hydraulic seal or causing hydraulic fluid to leak between the two sliding surfaces. The optimized metallic thermal spray coating can achieve a surface finish which has a combination of roughness characteristics consisting of an arithmetical mean roughness, a maximum profile peak height, a mean roughness depth designated, skewness, and a roughness relative material ratio, each of which is within well-defined upper limits and/or ranges.

### FIELD OF THE INVENTION

The present invention generally relates to coatings that are optimized with a surface finish suitable for preventing leakage or without damaging seal components. Particularly, the optimized metallic thermal spray coating has a specific combination of surface roughness parameters, each of which has defined upper limits and/or ranges that produces an exceptional surface finish coating capable of providing improved seal performance over conventional HVOF (High Velocity Oxy-Fuel) metallic coatings.

### BACKGROUND OF THE INVENTION

Hydraulic systems are used in a variety of applications, including aerospace, construction equipment, agricultural equipment, and other machinery. As part of the hydraulic system, hydraulic cylinders initiate pressure of a fluid and then converts the energy of the fluid into a force that moves the cylinder in a linear direction. The hydraulic cylinder consists of a cylinder barrel, in which a piston connected to a piston rod moves back and forth. Friction between a cylinder rod and its seals can result in wear and has a crucial influence on the efficiency and service life of hydraulic cylinders. Frictional properties of the piston-rod and the seals are becoming increasingly important to the operators of modern fluid-power systems.

Coatings can be applied to the piston rod and other sliding components. Surface roughness parameters of the finished coating affect frictional characteristics, coating and seal wear, fluid leakage rate, and overall performance of the hydraulic system.

Traditionally, hard-chrome plating has been applied on hydraulic piston rods and hydraulic cylinders. However, the plating process of hard-chrome contains hexavalent chromium (VI), which is toxic and heavily regulated by the U.S. Environmental Protection Agency (EPA). It is a human carcinogen, and the EPA considers it a hazardous air pollutant under the Clean Air Act, a hazardous substance under the Clean Water Act, and a hazardous waste under the Resource Conservation and Recovery Act. Therefore, the by-products of the plating process are strongly regulated.

Carbide based coatings applied by HVOF (High Velocity Oxy-Fuel) or other thermal spray processes are used as an alternative for hard chrome plating. However, due to high hardness and typically angular morphology of carbide grains acting like abrasives, such coating can potentially be damaging to the mating surface of polymeric and metallic seals and cause fluid leakage.

Metallic coatings applied by HVOF, contrary to carbide-based coatings, are more “friendly” against mating seals. Finishing of such coatings presents a certain challenge in that it is difficult to replicate the same surface finish characteristics as can be achieved with conventional carbide-based coatings.

In view of the above-mentioned drawbacks, there is an unmet need for an improved, environmentally friendly coating suitable for sliding against hydraulic seals which produces comparable wear of the seals to that attained with chrome plate.

### SUMMARY OF THE INVENTION

The invention may include any of the following aspects in various combinations and may also include any other aspect of the present invention described below in the written description.

Other aspects, features and embodiments of the disclosure will be more fully apparent from the ensuing description and appended claims.

In a first aspect, an optimized metallic thermal spray coating suitable for sliding against—a surface of a hydraulic seal without damaging the surface of the hydraulic seal said optimized metallic thermal spray coating having a measured surface finish defined as a combination of (i) an arithmetical mean roughness designated as (Ra) between about 2-5 microinches; (ii) a maximum profile peak height designated as (Rp) no greater than about 8 microinches; (iii) a mean roughness depth designated as (Rz) no greater than about 40 microinches; (iv) a skewness designated as (Rsk) between about −0.1 to −3.0; and (v) a roughness relative material ratio designated as Rₘᵣ(p,d_{c}) determined using ISO 21920-2:2021, wherein Rₘᵣ(p,d_{c}) is the percentage of the coating above a predetermined depth, wherein Rₘᵣ(p,d_{c}) is between 70-90% of the material above the predetermined depth, wherein p represents an amount of topmost material to exclude due to false readings and has a value equal to p=5% of the material depth measured from a highest peak, and dc represents the predetermined depth as measured from a starting depth equal to a value of p followed by traversing down into the material the predetermined depth by an amount equal to dc, where d_{c}=−0.25*Rz as defined by hydraulic industry standards; said optimized metallic thermal spray coating comprising a high velocity oxygen fuel (HVOF) sprayed gas atomized fine powder, said high velocity oxygen fuel (HVOF) sprayed gas, pre-alloyed atomized fine powder comprising a metallic alloy, said metallic alloy having a particle size distribution where a 10^{th} percentile of the particle size distribution designated as d10 has a diameter of less than or equal to about 5 microns and a 90^{th} percentile of the particle size distribution designated as d90 has a diameter of less than or equal to about 15 microns.

In a second aspect, a method for creating an optimized metallic thermal spray coating with a desired finish, comprising the step of: providing a gas atomized, pre-alloyed fine powder, said gas atomized, pre-alloyed fine powder comprising a metallic alloy, said metallic alloy having a particle size distribution where a 10^{th} percentile of the particle size distribution has a diameter of less than or equal to about 5 microns, and a 90^{th} percentile of the particle size distribution has a diameter of less than or equal to about 15 microns; providing a sliding component; providing a high velocity oxygen fuel (HVOF) thermal spray torch, said torch comprising a combustion chamber with a nozzle downstream of the combustion chamber; pre-mixing oxygen gas with an inert gas to produce diluted oxygen, wherein the pre-mixing occurs prior to the oxygen gas entering a combustion chamber; introducing the diluted oxygen gas into the combustion chamber; introducing a fuel into the combustion chamber; combusting the fuel with the diluted oxygen gas to generate a flame; introducing the pre-alloyed, gas atomized fine powder into the nozzle; heating the pre-alloyed, gas atomized powder with the flame to produce substantially molten and semi-molten droplets; and directing the substantially molten and semi-molten droplets to a surface of the sliding hydraulic component to produce an as-deposited coating; superfinishing the as-deposited coating to produce the desired surface finish on the coating.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1a shows a three-dimensional microscopy image of a metallic coating applied using a pre-alloyed metallic powder with powder size distribution (PSD1) and a conventional HVOF coating process after performing the step of superfinishing;

FIG. 1b shows a two-dimensional microscopy image of FIG. 1a, and further provides a numerical scale to indicate the depth of the pits or pullouts in the coating of FIG. 1a;

FIG. 2a shows a three-dimensional microscopy of another metallic coating applied using a pre-alloyed metallic powder with powder size distribution (PSD2), and a conventional HVOF coating process after performing the step of superfinishing;

FIG. 2b shows a two-dimensional microscopy image of FIG. 2a, and further provides numerical scale to indicate the depth of the pits or pullouts in the coating of FIG. 2a;

FIG. 3a shows a three-dimensional microscopy image of a coating in accordance with the principles of the present invention after performing the step of superfinishing;

FIG. 3b shows a two-dimensional microscopy image of FIG. 3a, and further provides a numerical scale to indicate the depth of the pits or pullouts in the coating of FIG. 3a, which are significantly less in comparison to that of FIG. 2b and FIG. 1b;

FIGS. 4a, 4b and 4c show corresponding images of the superfinished coatings of FIGS. 1a, 2a and 3a, where the presence of dark regions represents pits or pullouts created in the coating after the step of superfinishing; and

FIG. 5a shows the evaluation length roughness profile; and

FIG. 5b corresponds to FIG. 5a and shows the Rmr value along the x-axis and the depth of the material along the y-axis.

### DETAILED DESCRIPTION OF THE INVENTION

The disclosure is set out herein in various embodiments, and with reference to various features and aspects of the invention. The disclosure contemplates such features, aspects and embodiments in various permutations and combinations, as being within the scope of the disclosure. The disclosure may therefore be specified as comprising, consisting or consisting essentially of, any of such combinations and permutations of these specific features, aspects and embodiments, or a selected one or ones thereof.

As will be described, the present invention offers a metallic HVOF coating capable of achieving a desirable surface finish having surface roughness parameters that represent a significant improvement over conventional metallic thermal spray coatings.

Unless indicated otherwise, all compositions herein are in weight percentage.

The terms “conventional HVOF” and “standard HVOF” are used interchangeably and are intended to mean a thermal spray coating that cannot be superfinished to create the combination of surface roughness parameters described and claimed herein.

“Optimized metallic thermal spray coating” as used herein and throughout is intended to mean a thermal spray coating able to achieve desirable surface roughness parameters such that it slides against a hydraulic seal without damaging the surface of the hydraulic seal.

For consistency, it should be understood that all of the surface roughness parameters are expressed in accordance with ISO standards, and surface measurements in the experimental tests described hereinbelow were obtained in accordance with applicable ISO Standard 4288-1996.

The present invention relates to a novel coating produced from the pre-alloyed metallic powder that meets surface finished characteristics of carbide coatings. As will be discussed, the coating finish has been specifically designed to have a combination of five specific roughness parameters consisting of (i) an arithmetical mean roughness designated as (Ra); (ii) a maximum profile peak height designated as (Rp); (iii) a mean roughness depth designated as (Rz); (iv) a degree of skew designated as (Rsk); and (v) a roughness relative material ratio designated as Rₘᵣ(p,d_{c}). As will be discussed hereinbelow, each of the roughness parameters (i), (ii), (iii), (iv) and (v) is maintained at specific values or within a particular range. The inventors have discovered that producing a coating that exhibits each of the five roughness parameters at a particular value or within the prescribed range creates an optimized surface profile suitable for sliding against the seal components without damaging the mating seals. The finish of the coating translates into minimal damage to the seal by the piston rod surface of a hydraulic system, thereby improving seal integrity and maintaining a leak-free seal between the mating surfaces of the sliding components. In this manner, the present invention offers exceptional seal performance.

The first surface finishing parameter of the present invention is an arithmetical mean roughness designated as (Ra) between about 2-5 microinches. Ra measures the average length between the peaks and valleys and the deviation from the mean line on the entire surface within the sampling length. It is the arithmetic average of all of the absolute values of the profile height deviations from the mean line. Maintaining Ra values within a range of about 2-5 microinches. minimizes the peaks of the coating.

However, Ra by itself is not sufficient to properly create an optimized coating finish for hydraulic systems. The second surface finishing parameter required is a maximum profile peak height designated as (Rp). Rp is no greater than about 8 microinches. Rp represents the maximum peak of a surface profile within the sampling length.

The third surface finishing parameter is a mean roughness depth designated as (Rz). Rz represents the average of the vertical distances from the highest peak to the lowest valley that is measured within the sampling lengths. The present invention requires the Rz value to be no greater than about 40 microinches.

The fourth surface finishing parameter is a degree of skew designated as (Rsk). Rsk is a numerical indicator of the surface profile that represents the degree of non-symmetry. Rsk is unitless and is required to have a value between about −0.1 to −3.0, which is indicative of a negative skewness profile. A negative skewness profile is generally indicative of a coated surface profile that has more valleys than peaks.

The fifth surface finishing parameter is a Roughness Relative Material ratio designated as Rₘᵣ(p,d_{c}) determined using ISO 21920-2:2021. Rₘᵣ(p,dc) is indicative of the amount of material that is located within a certain depth of the coating material. Rₘᵣ(p,dc) is expressed as a percentage of the material whereby between 70-90% of the material sample is required to be present above a predetermined depth. The predetermined depth is determined by traversing down into the material by an amount equal to de from a starting point equal to a value of p, where p represents an amount of topmost material to exclude due to potential false readings. P is equal to 5% of the material depth measured from a highest peak. De represents the predetermined depth as measured from a starting depth equal to a value of p followed by traversing down into the material by an amount dc that is equal to 0.25*Rz, where Rz is the mean roughness depth described hereinabove. The Rmr value between 70-90% ensures there is an adequate amount of material to impart sufficient wear resistance and maintain seal integrity and performance.

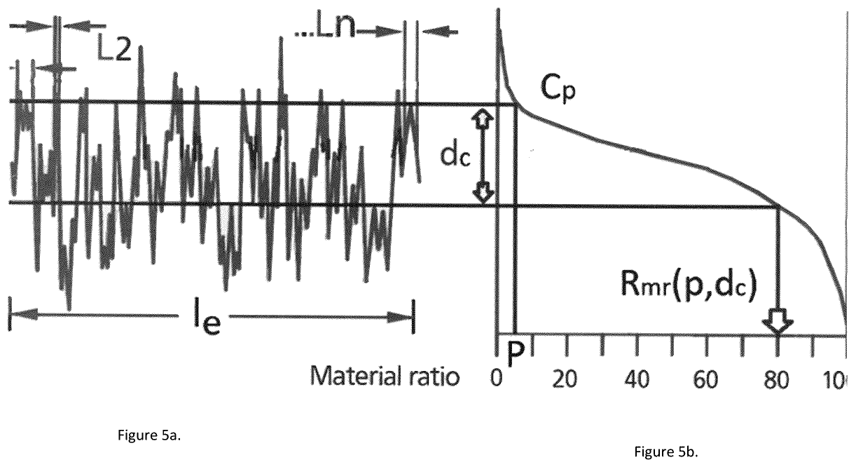

An illustrative example of an Rmr value that falls between 70-90% in accordance the present invention is shown in FIG. 5a and FIG. 5b. FIG. 5a shows a surface profile within depth dc. Taking the sum of each of the material lengths designated as Ln along the evaluation length designated as Le and dividing by Le provides the percentage of coating material at depth dc, which represents the vertical distance into the coating material measured from p. In particular, at a depth of dc, FIG. 5b shows that 80% of the coating material resides above depth dc. Such a relatively high amount of material assists with seal integrity to the hydraulic system. FIG. 5a represents one data point along the curve of FIG. 5b. FIG. 5b graphically is constructed by plotting the evaluation length roughness profile and drawing a horizontal line at various depths from the highest peak. From the depth, the total length as a percentage of evaluation length is calculated. The process is repeated from 0 to 100% and from highest peak to lowest valley as shown in FIGS. 5a and 5b.

The optimized metallic thermal spray coating has a surface that is substantially free of pullouts.

A method of creating the optimized metallic thermal spray coating will now be described. The powder utilized to produce the coating is pre-alloyed and gas atomized. The powder has a particle size distribution defined by a 10^{th} percentile of the particle size distribution having a diameter of less than or equal to about 5 microns, and a 90^{th} percentile of the particle size distribution having a diameter of less than or equal to about 13 microns. In a preferred embodiment, the 50^{th} percentile of the particle size distribution has a diameter of about 8 microns.

A modified high velocity oxy-fuel (HVOF) process is utilized to spray the pre-alloyed, gas atomized fine powder. As part of the modified HVOF process, oxygen is pre-mixed with an inert gas to produce a diluted oxygen stream. The pre-mixing occurs prior to the oxygen entering the combustion chamber of a HVOF thermal spray torch. The flow ratio of the inert gas to the oxygen ranges from 8:92 to 50:50, preferably between 10:90 to 30:70 and more preferably between 12:88 to 18:82. Further details for creating the diluted oxygen stream are disclosed in Applicants' application U.S. Patent Pub. No. 2020/0048573, which is incorporated by reference in its entirety for all purposes.

After the diluted oxygen stream is created, it is fed into the combustion chamber where it combusts with a suitable hydrocarbon fuel (e.g., kerosene) to generate a flame. The pre-alloyed, gas atomized fine powder is then fed into the spray nozzle where it is heated to a molten or semi-molten state. The heated powder is directed onto a surface of a sliding hydraulic component to produce an as-deposited coating. The as-deposited coating is then superfinished by applying an abrasive film onto the coating at a predetermined abrasive oscillation and pressure. The net result is an optimized metallic thermal spray coating having the combination of surface finish parameters discussed.

The combination of roughness characteristics (i)-(v) with defined upper limits and/or ranges provides an exceptional surface finish coating capable of providing improved seal performance over conventional HVOF carbide based and metallic coatings. The testing in the Comparative Examples 1-4 and Examples validate the superior finishing of the inventive coatings relative to that of conventional metallic thermal spray coatings.

As will be shown and discussed below in the Working Examples, several experiments were performed to compare the optimized metallic thermal spray coatings of the present invention with conventional HVOF metallic coatings applied from pre-alloyed, gas atomized metallic powders. The criteria for a successful test was dependent upon the coating's ability to satisfy all of the following requirements: (i) an arithmetical mean roughness designated as (Ra) between about 2-5 microinches; (ii) a maximum profile peak height designated as (Rp) no greater than about 8 microinches; (iii) a mean roughness depth designated as (Rz) no greater than about 40 microinches; (iv) a degree of skew designated as (Rsk) between about −0.1 to −3.0; and (v) a roughness relative material ratio designated as Rₘᵣ(p,d_{c}) determined using ISO 21920-2:2021, where Rₘᵣ(p,d_{c}) is the percentage of the material above a predetermined depth and has a value of 70-90% of the material above the predetermined depth.

The tests utilized pre-alloyed, metallic, gas atomized powders with one of the following particle size distributions (“PSD”) was utilized for each of the tests:

| | D10 | D50 | D90 |
|---|---|---|---|
| PSD 1 | 25.1 μm | 38.1 μm | 53.7 μm |
| PSD 2 | 12.4 μm | 17.1 μm | 24.8 μm |
| PSD 3 | 4.7 μm | 7.8 μm | 13.0 μm |

### Comparative Example 1 (PSD1)

A pre-alloyed, gas atomized powder having the formulation 42 wt % W, 34 wt % Cr, 20 wt % Co and 4 wt % C was employed to produce a coating onto a test substrate using a conventional High Velocity Oxygen Fuel (“HVOF”) coating process. Oxygen and kerosene were axially introduced separately into the inlet of the combustion chamber of a commercially available thermal spray HVOF torch made by Praxair TAFA). Pre-alloyed gas atomized powder was injected into the spray nozzle. The pre-alloyed gas atomized powder had a particle size distribution designated as PSD1 in which a 10^{th} percentile of the particle size distribution had a diameter of less than or equal to about 25.1 microns and a 90^{th} percentile of the particle size distribution had a diameter of less or equal to about 53.7 microns. The 50^{th} percentile was 38.1 microns. The oxygen gas was not pre-mixed with an inert gas. The pre-alloyed gas atomized powder was injected into the spray nozzle. Nitrogen carrier gas was used to convey the pre-alloyed gas atomized powder into the spray nozzle.

The test substrate of 2 inches diameter to be coated was rotating at 900 inch per minute surface speed while the thermal spray torch was traversed across the substrate at 28.6 inches per minute. The standoff distance between the torch and part was 15 inches. In this manner, the coating was formed on the test substrate.

The as-deposited coating was superfinished by applying an abrasive film onto the coating at a predetermined abrasive oscillation and pressure. With the coated substrate rotating, the abrasive film traversed the coating surface in a side-to-side pattern in an attempt to produce the required surface finished pattern.

After the superfinishing was completed, the measurements of the superfinished coating were performed with a profilometer stylus, which consisted of a 2-micron radius tip skidded probe. Various parameters, such as cutoff length, evaluation length and sampling length were set in accordance with the ISO Standard 4288-1996 to collect the surface roughness measurements. The profilometer stylus traversed the coated surface an evaluation length of 0.157 in. to collect the data for purposes of calculating the roughness parameters. In this manner, surface roughness measurements were collected along the evaluation length of the surface of the superfinished coating. A cutoff length (i.e., sample length) of 0.032 inches was utilized to filter out roughness waviness of the primary profile of raw data to ensure the remaining data only contained the roughness profile to be captured, as the primary profile may have contained some longer waviness that can interfere with the roughness measurements of interest to be captured in the raw data. The results of the superfinishing were Ra: 4.41 μin; Rp: 6.27 μin; Rz: 90.8 μin; Rsk: −7.8; and Rₘᵣ: 96.48%. The measurements indicated that the values for Rz. Rsk, Rₘᵣ(p,d_{c}) did not meet the required surface finish criteria.

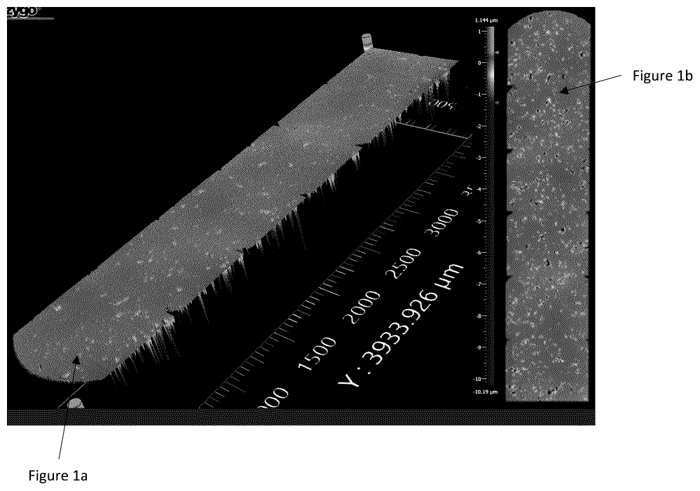

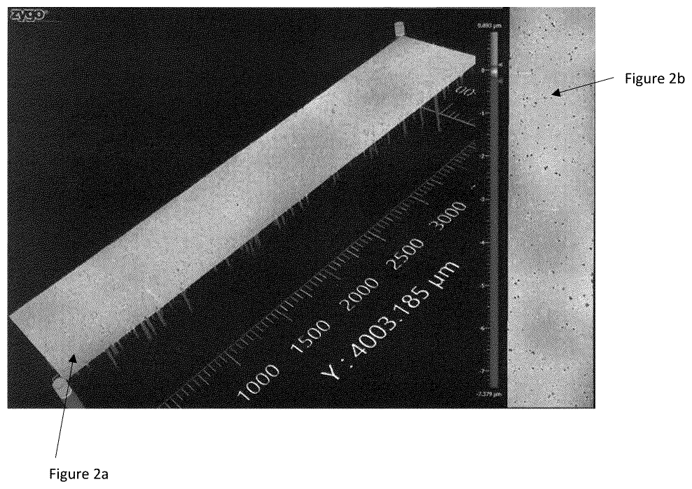

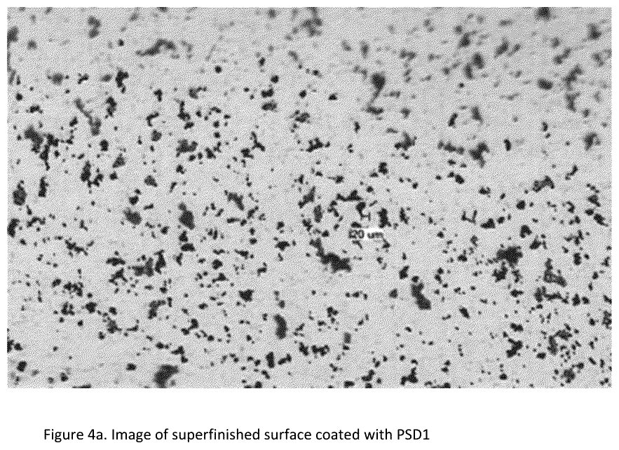

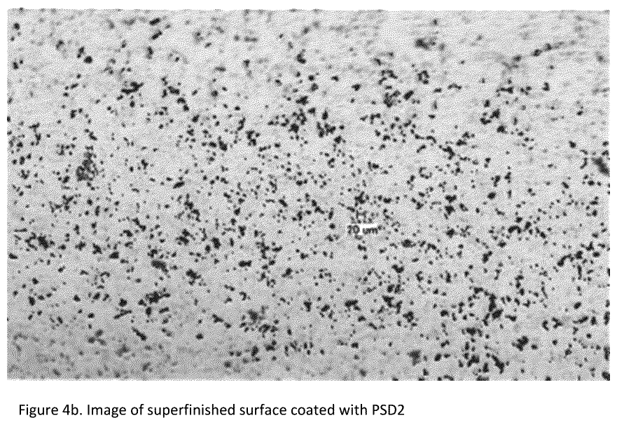

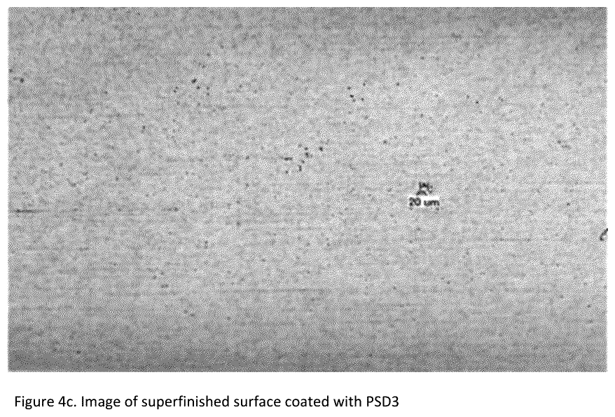

FIG. 1a shows a 3d microscopy image of the superfinished coating. FIG. 1a represents an isometric view of the surface of the superfinished coating to reveal peaks and valleys extending into the coating surface. FIG. 1a illustrates mostly downward needles. The downward needles indicate the number and size of the pits (i.e., the depth of the imperfection) that were created from the superfinishing step. FIG. 1b is a vertical two-dimensional image of FIG. 1a and provides a numerical scale that corresponds to the size of the valleys or pits of FIG. 2a. FIG. 4b shows an optical microscopy image of the superfinished coating. The image is intended to show the number and size of any pits that were created after the superfinishing step of the as-deposited coating. The dark regions indicate the pits in the superfinished coating. The pits are indicative of a coating with roughness measurements that did not meet applicable criteria.

### Comparative Example 2 (PSD2)

A pre-alloyed, gas atomized powder having the formulation 42 wt % W, 34 wt % Cr, 20 wt % Co and 4 wt % C was employed to produce a coating onto a test substrate using a conventional High Velocity Oxygen Fuel (“HVOF”) coating process. Oxygen and kerosene fuel were axially introduced separately into the inlet of the combustion chamber of a commercially available thermal spray HVOF torch (Praxair TAFA) and the pre-alloyed gas atomized powder was injected into the spray nozzle. The pre-alloyed gas atomized powder had a particle size distribution designated as PSD2 in which a 10^{th} percentile of the particle size distribution had a diameter of less than or equal to about 12.4 microns and a 90^{th} percentile of the particle size distribution had a diameter of less or equal to about 24.8 microns. The 50^{th} percentile was 17.1 microns. The pre-alloyed gas atomized powder was injected into the spray nozzle. Nitrogen carrier gas was used to convey the pre-alloyed gas atomized powder into the spray nozzle.

The attempt to apply the pre alloyed powder with this particle size distribution through the conventional liquid HVOF thermal spray torch failed as a result of severe powder adherence to the walls of the nozzle. The HVOF process was aborted, and no coating was produced.

### Comparative Example 3 (PSD2)

A pre-alloyed, gas atomized powder having the formulation 42 wt % W, 34 wt % Cr, 20 wt % Co and 4 wt % C was employed to produce a coating onto a test substrate using a modified HVOF coating process that pre-mixed oxygen with an inert gas. The pre-mixed oxygen and kerosene fuel were axially introduced separately into the inlet of the combustion chamber of a commercially available thermal spray torch (made by Praxair TAFA) and the pre-alloyed gas atomized powder was injected into the spray nozzle. The pre-alloyed gas atomized powder designated as PSD2 had a particle size distribution in which a 10^{th} percentile of the particle size distribution had a diameter of less than or equal to about 12.4 microns and a 90^{th} percentile of the particle size distribution had a diameter of less or equal to about 24.8 microns. The 50^{th} percentile was 17.1 microns. Nitrogen carrier gas was used to convey the pre-alloyed gas atomized powder into the spray nozzle.

The test substrate of 2 inches diameter to be coated was rotating at 2400 inch per minute surface speed while the thermal spray torch was traversed and indexed across the substrate at 76.4 inches per minute. The standoff distance between the torch and part was 10 inches. In this manner, the coating was formed on the test substrate.

The as-deposited coating was superfinished by applying an abrasive film onto the coating at a predetermined abrasive oscillation and pressure. With the coated substrate rotating, the abrasive film traversed the coating surface in a side-to-side pattern to produce the desired surface finish parameters.

After the superfinishing was completed, the measurements of the superfinished coating were performed with a profilometer stylus, which consisted of a 2 micron radius tip skidded probe. Various parameters, such as cutoff length, evaluation length and sampling length were set in accordance with the ISO Standard 4288-1996 to collect the surface roughness measurements. The profilometer stylus traversed the coated surface with an evaluation length of 0.157 in to collect the data for purposes of calculating the roughness parameters. In this manner, surface roughness measurements were collected along the evaluation length of the surface of the superfinished coating. A cutoff length of 0.032 inches was utilized to filter out roughness waviness of the primary profile of raw data to ensure the remaining data only contained the roughness profile, as the primary profile may have contained some longer waviness that may have interfered with the roughness measurements of interest in the captured raw data. The results of the superfinishing were Ra: 2.61 μin; Rp: 7.2 μin; Rz: 64.41 μin; Rsk: −6.261; and Rₘᵣ(p,d_{c}): 96.74%. The measurements indicate that the values for Rz, Rₘᵣ(p,d_{c}) and Rsk did not meet the required surface finish criteria.

FIG. 2a shows a 3d microscopy image of the coating and represents an isometric view of the surface of the superfinished coating to reveal peaks and valleys extending into the coating surface. FIG. 2a illustrates mostly downward needles. The downward needles indicate the number and size of the pits (i.e., the depth of the imperfection) created from the superfinishing step. FIG. 2b is a vertical 2d image of FIG. 2a and provides a numerical scale that corresponds to the size of the valleys or pits of FIG. 2a. Collectively, FIGS. 2a and 2b show less pits than the coating produced in Comparative Example 1. Specifically, the coating exhibited Rsk and Rz values that were less out of specification than that of Comparative Example 1. However, the size and number of the pits in the coating remained unacceptably high and caused the coating to not meet the applicable criteria for surface roughness measurement. FIG. 4b shows an optical microscopy image of the superfinished coating. The images are intended to show the number and size of any pits that were created after the superfinishing step of the as-deposited coating. The dark voids indicate the pits in the superfinished coating. The pits are indicative of a coating with roughness measurements that did not meet applicable criteria. FIG. 4b indicates smaller pits than those created in FIG. 4a.

### Comparative Example 4 (PSD3)

A pre-alloyed, gas atomized powder having the formulation 42 wt % W, 34 wt % Cr. 20 wt % Co and 4 wt % C was employed to produce a coating onto a test substrate using a conventional High Velocity Oxy-Fuel (“HVOF”) coating process. Oxygen and kerosene fuel were axially introduced separately into the inlet of the combustion chamber of a commercially available thermal spray torch (made by Praxair TAFA) and the pre-alloyed gas atomized powder was injected into the spray nozzle. The pre-alloyed gas atomized powder had a particle size distribution in which a 10^{th} percentile of the particle size distribution had a diameter of less than or equal to about 4.7 microns and a 90^{th} percentile of the particle size distribution had a diameter of less or equal to about 13.0 microns. The 50^{th} percentile was 7.8 microns. The pre-alloyed gas atomized powder was injected into the spray nozzle. Nitrogen carrier gas was used to convey the pre-alloyed gas atomized powder into the spray nozzle. The attempt to apply the pre alloyed powder with this particle size distribution through the conventional HVOF thermal spray torch failed as a result of severe powder adherence to the walls of the nozzle. The HVOF process was aborted, and no coating was produced.

### Example 1 (Invention—PSD3)

A pre-alloyed, gas atomized powder having the formulation 42 wt % W, 34 wt % Cr. 20 wt % Co and 4 wt % C was employed to produce a coating onto a test substrate using a modified High Velocity Oxy-Fuel (“HVOF”) coating process that pre-mixed oxygen with an inert gas. The pre-mixed oxygen and kerosene fuel were axially introduced separately into the inlet of the combustion chamber of a commercially available thermal spray torch (made by Praxair TAFA) and the pre-alloyed gas atomized powder was injected into the spray nozzle. The pre-alloyed, gas atomized powder had a particle size distribution designated as PSD3 in which a 10^{th} percentile of the particle size distribution had a diameter of less than or equal to about 4.7 microns and a 90^{th} percentile of the particle size distribution had a diameter of less than or equal to about 13.0 microns. The 50^{th} percentile was 7.8 microns. Nitrogen carrier gas was used to convey the pre-alloyed gas atomized powder into the spray nozzle.

The test substrate of 2 inches diameter to be coated was rotating at 2400 inch per minute surface speed while the thermal spray torch was traversed and indexed across the substrate at 76.4 inches per minute. The standoff distance between the torch and part was 10 inches. In this manner, the coating was formed on the test substrate.

The as-deposited coating was superfinished by applying an abrasive film onto the coating at predetermined abrasive oscillation and pressure. With the coated substrate rotating, the abrasive film traversed the coating surface in a side-to-side pattern in an attempt to produce the required surface finish parameters.

After the surface finishing was completed, the measurements of the superfinished coating were performed with a profilometer stylus, which consisted of a 2-micron radius tip skidded probe. Various parameters, such as cutoff length, evaluation length and sampling length were set in accordance with the ISO Standard 4288-1996 to collect the surface roughness measurements. The profilometer stylus traversed the coated surface an evaluation length of 0.157 inch to collect the data for purposes of calculating the roughness parameters. In this manner, surface roughness measurements were collected along the evaluation length of the surface of the superfinished coating. A cutoff length of 0.032 inches was utilized to filter out roughness waviness of the primary profile of raw data to ensure the remaining data only contained the roughness profile, as the primary profile may have contained some longer waviness that may have interfered with the roughness measurements of interest in the captured raw data. The results of the superfinishing were Ra: 3.23 μin; Rp: 6.2 μin; Rz: 37.49 μin; Rsk: −2.6; and Rₘᵣ(p,d_{c}): 87.7%. The measurements indicate that each of the surface finish values for Ra, Rp, Rz, Rmr and Rsk met the required surface finish criteria.

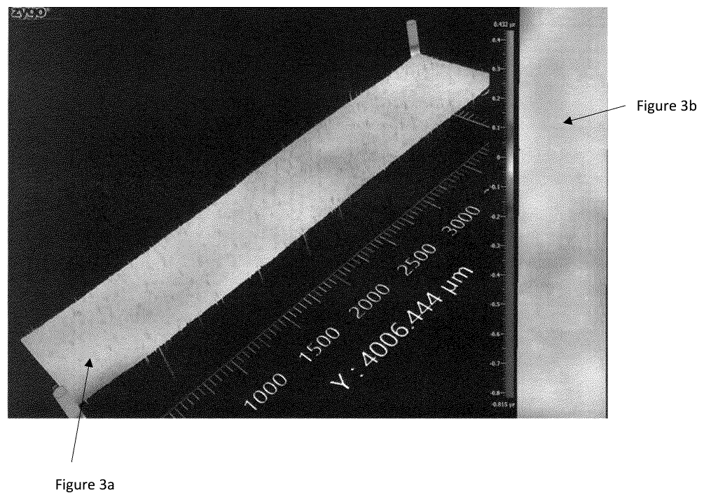

FIG. 3a shows a three-dimensional microscopy image of the coating and represents an isometric view of the surface of the superfinished coating to reveal peaks and valleys extending into the coating surface. FIG. 3a illustrates less downward needles than those produced in Comparative Example 1 (FIGS. 1a and 1b) and Comparative Example 3 (FIGS. 2a and 2b). The downward needles indicate the number and size of the pits (i.e., the depth of the imperfection) created from the superfinishing step. FIG. 3b is a vertical two-dimensional image of FIG. 3a and provides a numerical scale that corresponds to the size of the valleys or pits of FIG. 2a. Collectively, FIGS. 3a and 3b show a reduced number of pits and smaller sized pits in comparison to the superfinished coatings produced in Comparative Example 1 and Comparative Example 3. FIG. 4c shows an optical microscopy image of the superfinished coating. The images are intended to show the number and size of any pits that were created after the superfinishing step of the as-deposited coating. Virtually no dark regions can be seen. The lack of pits and relatively small size of the pits are indicative of a coating with roughness characteristics that met applicable criteria.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described. nor to anything less than the whole of the invention herein disclosed and hereinafter claimed.

1. An optimized metallic thermal spray coating suitable for sliding against—a surface of a hydraulic seal without damaging the surface of the hydraulic seal, said optimized metallic thermal spray coating having a measured surface finish defined as a combination of (i) an arithmetical mean roughness designated as (Ra) between about 2-5 microinches; (ii) a maximum profile peak height designated as (Rp) no greater than about 8 microinches; (iii) a mean roughness depth designated as (Rz) no greater than about 40 microinches; (iv) skewness designated as (Rsk) between about −0.1 to −3.0; and (v) a roughness relative material ratio designated as Rₘᵣ(p,d_{c}) determined using ISO 21920-2:2021, wherein Rₘᵣ(p,d_{c}) is the percentage of the coating above a predetermined depth, wherein Rₘᵣ(p,d_{c}) is between 70-90% of the material above the predetermined depth, wherein p represents an amount of topmost material to exclude due to false readings and has a value equal to p=5% of the material depth measured from a highest peak, and d_{c} represents the predetermined depth as measured from a starting depth equal to a value of p followed by traversing down into the material the predetermined depth by an amount equal to d_{c}, where d_{c}=−0.25*Rz as defined by hydraulic industry standards;
said optimized metallic thermal spray coating comprising a high velocity oxygen fuel (HVOF) sprayed gas atomized fine powder, said high velocity oxygen fuel (HVOF) sprayed gas, pre-alloyed atomized fine powder comprising a metallic alloy, said metallic alloy having a particle size distribution where a 10^{th} percentile of the particle size distribution designated as d10 has a diameter of less than or equal to about 5 microns and a 90^{th} percentile of the particle size distribution designated as d90 has a diameter of less than or equal to about 15 microns.

2. The optimized metallic thermal spray coating of claim 1, further comprising a 50^{th} percentile of the particle size distribution of about 8 microns.

3. The optimized metallic thermal spray coating of claim 1, further comprising a Vickers hardness greater than about 850 HV and less than about 1500 HV.

4. The optimized metallic thermal spray coating of claim 1, further comprising a structure that is substantially free of pullouts.

5. The optimized metallic thermal spray coating of claim 1, further comprising a structure that is substantially free of ceramic particles.

6. The optimized metallic thermal spray coating of claim 1, wherein the metallic alloy of the high velocity oxygen fuel (HVOF) spray gas atomized fine powder is selected from the group consisting of W, Co, Ni, Cr, V, Mo, Nb, Cu, Fe, Al, Ti, B, Si, and C.

7. A method for creating an optimized metallic thermal spray coating with a desired finish, comprising the step of:
providing a gas atomized, pre-alloyed fine powder, said gas atomized, pre-alloyed fine powder comprising a metallic alloy, said metallic alloy having a particle size distribution where a 10^{th} percentile of the particle size distribution has a diameter of less than or equal to about 5 microns, and a 90^{th} percentile of the particle size distribution has a diameter of less than or equal to about 15 microns;
providing a sliding component;
providing a high velocity oxygen fuel (HVOF) thermal spray torch, said torch comprising a combustion chamber with a nozzle downstream of the combustion chamber;
pre-mixing oxygen gas with an inert gas to produce diluted oxygen, wherein the pre-mixing occurs prior to the oxygen gas entering a combustion chamber;
introducing the diluted oxygen gas into the combustion chamber;
introducing a fuel into the combustion chamber;
combusting the fuel with the diluted oxygen gas to generate a flame;
introducing the pre-alloyed, gas atomized fine powder into the nozzle;
heating the pre-alloyed, gas atomized powder with the flame to produce substantially molten and semi-molten droplets; and
directing the substantially molten and semi-molten droplets to a surface of the sliding hydraulic component to produce an as deposited coating;
superfinishing the as-deposited coating to produce the desired surface finish on the coating.

8. The method of claim 7, wherein a flow ratio of the inert gas to the oxygen gas ranges from 8:92 to 50:50.

9. The method of claim 7, further comprising the gas atomized powder having a 50^{th} percentile of the particle size distribution with a diameter of about 8 microns.
